(19) United States
(12) Patent Application Publication
(10) Pub. No.: US 2024/0233982 A1
(43) Pub. Date: Jul. 11, 2024

(54) INSULATION COVERED CONDUCTIVE WIRE

(71) Applicants: FURUKAWA ELECTRIC CO., LTD., Tokyo (JP); JAPAN AEROSPACE EXPLORATION AGENCY, Chofu-shi (JP)

(72) Inventors: Tomoya NOMURA, Tokyo (JP); Yoichi ISO, Tokyo (JP); Hiroyuki TAMAOKA, Tokyo (JP); Shinatora CHO, Chofu-shi (JP); Satoshi HOSODA, Chofu-shi (JP)

(73) Assignees: FURUKAWA ELECTRIC CO., LTD., Tokyo (JP); JAPAN AEROSPACE EXPLORATION AGENCY, Chofu-shi (JP)

(21) Appl. No.: 18/556,118

(22) PCT Filed: Apr. 20, 2022
(86) PCT No.: PCT/JP2022/018314

§ 371 Date: Oct. 19, 2023

(30) Foreign Application Priority Data
Apr. 20, 2021 (JP) 2021-071313

(51) Int. Cl. H01B 7/29; H01B 3/12; H01B 7/02; H01F 5/06

(52) U.S. Cl. CPC H01B 7/292; H01B 3/12; H01B 7/0266; H01F 5/06

(57) ABSTRACT

The insulation covered conductive wire includes a conductive wire, a non-adherent, laterally wound insulation member and a non-adherent braided insulation member. The non-adherent, laterally wound insulation member covers an outer circumference of the conductive wire without adhering thereto and is formed by laterally winding a plurality of first ceramic fibers constituted from a plurality of first ceramic strands in an extending direction of the conductive wire. The first ceramic strands are not in contact with each other and do not adhere to each other. The non-adherent braided insulation member covers an outer circumference of the non-adherent, laterally wound insulation member without adhering thereto and is formed by braiding a plurality of second ceramic fibers constituted from a plurality of second ceramic strands. The second ceramic fibers are not in contact with each other and do not adhere to each other.

### TECHNICAL FIELD

The present disclosure relates to an insulation covered conductive wire.

### BACKGROUND ART

In recent years, the opportunities to use equipment under vacuum and high temperature are increasing. For example, electrostatic-acceleration type thrusters such as a Hall-effect thruster obtain propulsion by electrically discharging ions in plasma. For the electrostatic-acceleration type thrusters, a size reduction is easy compared to chemical thrusters using combustion of oxidant and propellant, and high propulsion efficiency and high specific thrust can be obtained. For this reason, the electrostatic-acceleration type thrusters can be considered for the application to thrusters suited to orbit control and attitude control of a spacecraft in outer space.

As the magnetic field generating coil equipped to the thruster of a spacecraft (hereinafter also referred to as spacecraft thruster) such as a Hall-effect thruster, an insulation covered conductive wire can be used. As an insulation covered conductive wire which can be used in the magnetic field generating coil of a spacecraft thruster, the application of a general insulation covered conductive wire including a ceramic insulation layer or a resin insulation layer on the outer circumference of a conductive wire is conceivable.

However, in outer space, there is a possibility of the spacecraft thruster reaching a high temperature more than the melting temperature or pyrolysis temperature of the resin insulation layer. In this case, the resin insulation layer is peeled from the insulation covered conductive wire or decomposed by deteriorating to carbide. In addition, in outer space, a spacecraft thruster repeats temperature change following the great temperature difference from very low temperature to high temperature. By such a temperature change, cracking in the ceramic insulation layer, and peeling of the ceramic insulation layer from the insulation covered conductive wire occur. In this way, when peeling of the resin insulation layer and cracking in the ceramic insulation layer occur, dielectric breakdown starting from these defective portions arises.

For example, Patent Document 1 describes a covered conductor made by forming an insulation coating layer consisting of a braided body of ceramic fibers on the outer circumference of an inner conductor, and forming an outer conductor consisting of a conductive fine wire on the outer circumference of the insulation coating layer. The covered conductor of Patent Document 1 does not include organic material.

### CITATION LIST

### Patent Document

Patent Document 1: Japanese Unexamined Patent Application, Publication No. H5-282924

### DISCLOSURE OF THE INVENTION

### Problems to be Solved by the Invention

Herein, even if the covered conductor of Patent Document 1 were exposed to the environment assumed to be in outer space, i.e. under vacuum and high temperature, it can be considered that the covered conductor can avoid carbonization of the resin insulation layer such as that described above. In addition, in the coated conductor of Patent Document 1, the outer conductor formed on the outer circumference of the insulation coated layer has a shielding effect on electrical interference from outside. In a case assuming to use the coated conductor of Patent Document 1 in an insulation covered conductive wire for the magnetic field generating coil of a spacecraft thruster, the induced current flows, and this coated conductor cannot generate a magnetic field. In this way, it is difficult to apply the coated conductor of Patent Document 1 to an insulation covered conductive wire for magnetic field generating coils.

In addition, in order to suppress dielectric breakdown starting from the above-mentioned defective portions, it has been considered to provide a heat shield to a conventional general insulation covered conductive wire. However, when the insulation covered conductive wire includes a heat shield, the size of the insulation covered conductive wire becomes larger. As a result thereof, for example, it becomes difficult to reduce the size of a spacecraft thruster. In addition, with a conventional insulation covered conductive wire, it is difficult to increase the voltage energizing to generate a magnetic field from the viewpoint of heat resistance of the resin insulation layer.

An object of the present disclosure is to provide an insulation covered conductive wire to be used in a magnetic field generating coil, having superior insulation property in a vacuum and at high temperature, which can be easily produced, and can achieve a size reduction and increased output.

### Means for Solving the Problems

An insulation covered conductive wire according to a first aspect of the present invention includes: a conductive wire; a non-adherent, laterally wound insulation member which covers an outer circumference of the conductive wire without adhering thereto, and is formed by laterally winding a plurality of first ceramic fibers constituted from a plurality of first ceramic strands in an extending direction of the conductive wire without being in close contact and adhering to each other; and a non-adherent braided insulation member which covers an outer circumference of the non-adherent, laterally wound insulation member without adhering thereto, and is formed by braiding a plurality of second ceramic fibers constituted from a plurality of second ceramic strands without being in close contact and adhering to each other.

According to a second aspect of the present invention, in the insulation covered conductive wire as described in the first aspect, the electrical resistivity of the conductive wire is 1×10⁻⁵ Ωcm or less at 25° C. under a pressure of 100 Pa, and 1×10⁻⁵ Ωcm or less at a temperature 100° C. lower than the melting temperature or pyrolysis temperature of the conductive wire under a pressure of 100 Pa.

According to a third aspect of the present invention, in the insulation covered conductive wire as described in the first or second aspect, the synthetic electrical resistivity of the non-adherent, laterally wound insulation member and the non-adherent braided insulation member is 1×10³ Ωcm or more at 25° C.

According to a fourth aspect of the present invention, in the insulation covered conductive wire as described in any one of the first to third aspects, the AC breakdown voltage in a vacuum of 100 Pa or less is 400 V or more.

According to a fifth aspect of the present invention, in the insulation covered conductive wire as described in any one of the first to fourth aspects, the non-adherent, laterally wound insulation member and the non-adherent braided insulation member are not pyrolytically decomposed at a temperature of 400° C. or higher.

### Effects of the Invention

According to the present disclosure, it is possible to provide an insulation covered conductive wire to be used in a magnetic field generating coil, having superior insulation property in a vacuum and at high temperature, which can be easily produced, and can achieve a size reduction and increased output.

### BRIEF DESCRIPTION OF THE DRAWINGS

FIG. 1 is a perspective view showing an example of an insulation covered conductive wire according to an embodiment.

FIG. 2 is an enlarged view of an area a in FIG. 1.

FIG. 3 is an enlarged view of an area b in FIG. 1.

FIG. 4 is a cross-sectional view showing an example of an insulation covered conductive wire according to an embodiment.

FIG. 5 is a schematic diagram showing an example of a usage example of the insulation covered conductive wire according to an embodiment.

### PREFERRED MODE FOR CARRYING OUT THE INVENTION

Hereinafter, the present disclosure will be explained in detail based on the embodiment.

The present inventors, as a result of intensive research, focused on the knitting structure of two types of the insulation members covering the outer circumference of the conductive wire, the coverage state without adhesion of these insulation members, as well as the non-use of organic materials, to achieve the insulation covered conductive wire which can be used in a magnetic field generating coil, having superior insulation property in a vacuum and at high temperature, with simplified production, a size reduction and increased output.

An insulation covered conductive wire 1 according to an embodiment includes: a conductive wire 10; a non-adherent, laterally wound insulation member 20 which covers an outer circumference 10a of the conductive wire 10 without adhering thereto, and is formed by laterally winding a plurality of first ceramic fibers 21 constituted from a plurality of first ceramic strands 22 in an extending direction of the conductive wire 10 without being in close contact and adhering to each other by an adhesive or the like; and a non-adherent braided insulation member 30 which covers an outer circumference 20a of the non-adherent, laterally wound insulation member 20 without adhering thereto, and is made by braiding a plurality of second ceramic fibers 31 constituted from a plurality of second ceramic strands 32 without being in close contact and adhering to each other by an adhesive or the like.

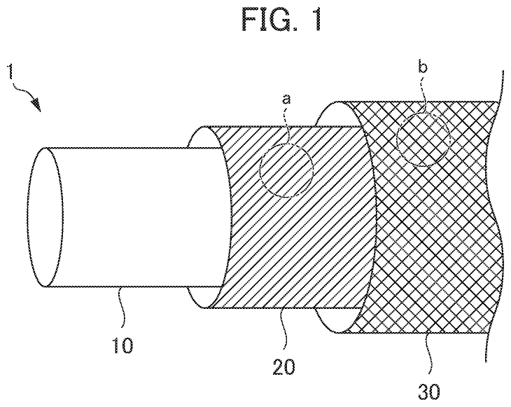

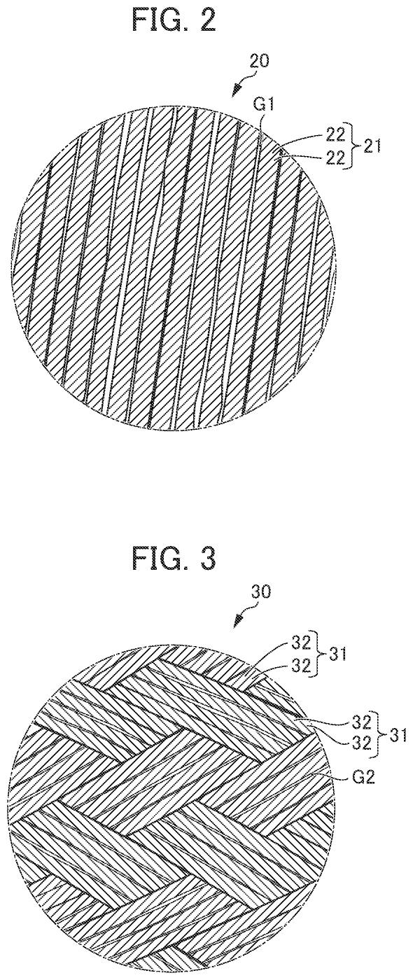

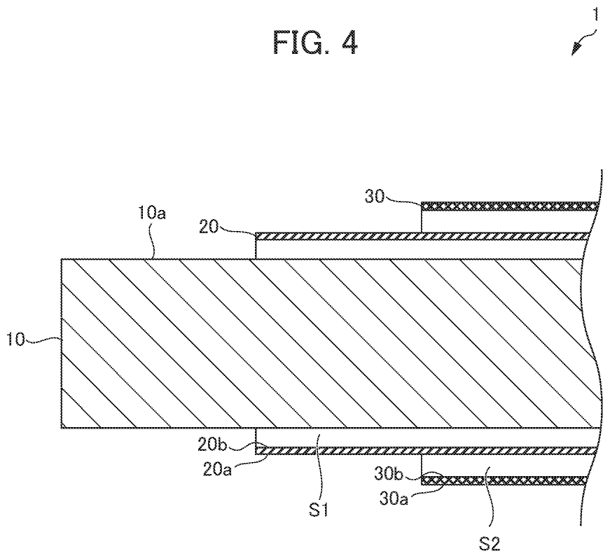

FIG. 1 is a perspective view showing an example of an insulation covered conductive wire according to an embodiment. FIG. 2 is an enlarged view of an area a in FIG. 1. FIG. 3 is an enlarged view of an area b in FIG. 1. FIG. 4 is a cross-sectional view showing an example of an insulation covered conductive wire. It should be noted that FIGS. 1 and 4 show an end of the insulation covered conductive wire 1 exposed by stripping the non-adherent, laterally wound insulation member 20 and the non-adherent braided insulation member 30, for convenience.

As shown in FIGS. 1 to 4, the insulation covered conductive wire 1 according to an embodiment includes a conductive wire 10, a non-adherent, laterally wound insulation member 20 and a non-adherent braided insulation member 30.

The conductive wire 10 constituting the insulation covered conductive wire 1 extends along a central axis of the insulation covered conductive wire 1. The conductive wire 10 is configured from at least one strand. For example, the conductive wire 10 can be exemplified by one consisting of a single strand as shown in FIG. 1, a stranded wire made by twisting multiple strands, a bundled wire made by bundling multiple strands without twisting, or the like. The conductive wire 10 may be compressed. The cross-sectional shape of the conductive wire 10 in a transverse section perpendicular to the longitudinal direction of the insulation covered conductive wire 1 may be circular, or may be rectangle. The conductive wire 10 is an internal conductive wire of the insulation covered conductive wire 1.

For the insulation covered conductive wire 1, from the viewpoint of having superior insulation property under a vacuum and at high temperature, and achieving higher output with space savings and electric power savings, the material constituting the conductive wire 10 is preferably a metal material with low electrical resistivity, and high melting temperature or high sublimation temperature, and is preferably a copper base material including copper and copper alloys such as brass, an aluminum base material including aluminum and aluminum alloys, a molybdenum base material including molybdenum and molybdenum alloys, a tungsten base material including tungsten and tungsten alloys, and carbon nanotube.

The electrical resistivity of the conductive wire 10 is preferably 1×10⁻⁵ Ωcm or less at 25° C. under a pressure of 100 Pa, and 1×10⁻⁵ Ωcm or less at a temperature 100° C. lower than the melting temperature or pyrolysis temperature of the conductive wire under a pressure of 100 Pa. When the electrical resistivity of the conductive wire 10 is within the above-mentioned range, the insulation covered conductive wire 1 has a superior insulation property under a vacuum and at high temperature, and can achieve higher output with space savings and electric power savings.

The wire diameter of the conductive wire 10 has a lower limit value of preferably 0.25 mm or more, and more preferably 0.60 mm or more, and has an upper limit value of preferably 1.00 mm or less, and more preferably 0.90 mm or less. If the wire diameter of the conductive wire 10 is within the above-mentioned ranges, the insulation covered conductive wire 1 can be reduced in size. For this reason, it is possible to suitably use the insulation covered conductive wire 1 for a magnetic field generating coil equipped to the thruster of a spacecraft achieving a size reduction.

The non-adherent, laterally wound insulation member 20 constituting the insulation covered conductive wire 1 covers the outer circumference 10a of the conductive wire 10. The non-adherent, laterally wound insulation member 20 does not adhere to the outer circumference 10a of the conductive wire 10. The non-adherent, laterally wound insulation member 20 is tubular, and covers the outer circumference 10a of the conductive wire 10 along the longitudinal direction of the insulation covered conductive wire 1. A space S1 exists between the outer circumference 10a of the conductive wire 10 and the inner circumference 20b of the non-adherent, laterally wound insulation member 20.

The non-adherent, laterally wound insulation member 20 is made by winding a plurality of first ceramic fibers 21 together laterally to the extending direction of the conductive wire 10 without being in close contact and adhering together. The plurality of first ceramic fibers 21 are configured from a plurality of first ceramic strands 22, respectively. In the non-adherent, laterally wound insulation member 20, a gap G1 exists between the plurality of first ceramic fibers 21.

Since the non-adherent, laterally wound insulation member 20 is covered by the non-adherent braided insulation member 30 from the outer side, adhesion between the conductive wire 10 and the non-adherent, laterally wound insulation member 20, and adhesion between multiple first ceramic fibers 21 are unnecessary.

As described above, the space S1 exists between the outer circumference 10a of the conductive wire 10 and the inner circumference 20b of the non-adherent, laterally wound insulation member 20, and the non-adherent, laterally wound insulation member 20 does not adhere to the outer circumference 10a of the conductive wire 10. Compared to a laterally wound insulation member adhering with the outer circumference 10a of the conductive wire 10 via an adhesive, the non-adherent, laterally wound insulation member 20 of the insulation covered conductive wire 1 can suppress cracking of the non-adherent, laterally wound insulation member 20 due to the temperature change accompanying a great temperature difference such as in outer space, caused by the difference between the thermal expansion of the conductive wire 10, thermal expansion of the non-adherent, laterally wound insulation member 20 and thermal expansion of the adhesive. For this reason, the insulation covered conductive wire 1 has a superior insulation property under a vacuum and at high temperature.

On the other hand, when using the insulation covered conductive wire 1 in an atmosphere such as on earth, since the space S1 exists between the conductive wire 10 and the non-adherent, laterally wound insulation member 20, the insulation property of the insulation covered conductive wire 1 is low compared to a conventional common insulation covered conductive wire. For this reason, in the case of using the insulation covered conductive wire 1 in the atmosphere, a restriction arises in the dielectric strength of the insulation covered conductive wire 1. For the insulation covered conductive wire 1 in a vacuum such as in outer space, the space S1 between the conductive wire 10 and the non-adherent, laterally wound insulation member 20 develops an insulation property, and thus functions as a gaseous insulation part.

In addition, the gap G1 exists between the multiple first ceramic fibers 21, and the multiple first ceramic fibers 21 are not in close contact and do not adhere with each other. Compared to a laterally wound insulation member in which the multiple first ceramic fibers 21 adhere via an adhesive, the non-adherent, laterally wound insulation member 20 of the insulation covered conductive wire 1 can suppress cracking of the non-adherent, laterally wound insulation member 20 due to the temperature change accompanying a great temperature difference caused by the difference between the thermal expansion of the first ceramic fiber 21 and the thermal expansion of the adhesive. For this reason, the insulation covered conductive wire 1 has a superior insulation property under a vacuum and at high temperature.

On the other hand, when using the insulation covered conductive wire 1 in the atmosphere, since the gap G1 exists between the multiple first ceramic fibers 21, the insulation property of the insulation covered conductive wire 1 is low compared to a conventional common insulation covered conductive wire. For this reason, in the case of using the insulation covered conductive wire 1 in the atmosphere, a restriction arises in the dielectric strength of the insulation covered conductive wire 1. For the insulation covered conductive wire 1 in a vacuum such as in outer space, the gap G1 between the multiple first ceramic fibers 21 develops an insulation property, and thus functions as a gaseous insulating part.

For the insulation covered conductive wire 1, from the viewpoint of having superior insulation property under a vacuum and at high temperature, and achieving higher output with space savings and electric power savings, the material constituting the non-adherent, laterally wound insulation member 20, i.e. the first ceramic strands 22, is preferably a ceramic material with high electrical resistivity, and high melting temperature or high sublimation temperature. The ceramic material is more preferably a combination of silicon dioxide, aluminum trioxide, diboron trioxide, calcium oxide and magnesium oxide, and may include a trace amount of metal oxide. The multiple first ceramic strands 22 constituting the non-adherent, laterally wound insulation member 20 may be the same type of ceramic material, or may be different types of ceramic materials. In addition, as a sublimating ceramic material, a silicon carbide (SiC) ceramic or the like can be considered.

The electrical resistivity of the non-adherent, laterally wound insulation member 20 is preferably 1×10⁶ Ωcm or more at 25° C. If the electrical resistivity of the non-adherent, laterally wound insulation member 20 is within the above-mentioned range, the insulation covered conductive wire 1 has superior insulation property under a vacuum and at high temperature, and can achieve higher output with space savings and electric power savings.

The non-adherent, laterally wound insulation member 20 is not pyrolytically decomposed even for a long period of time, e.g., kept for 1 hour, preferably at 400° C. or higher, and more preferably at 600° C. or higher. Due to the non-adherent, laterally wound insulation member 20 not being pyrolytically decomposed in the above temperature ranges, even if the insulation covered conductive wire 1 is raised in temperature, it is possible to maintain the insulation state by the non-adherent, laterally wound insulation member 20. For this reason, the insulation covered conductive wire 1 has superior insulation property under a vacuum and at high temperature, and can achieve higher output with space savings and electric power savings.

The thickness of the tubular non-adherent, laterally wound insulation member 20 has a lower limit value of preferably 10 μm or more, and more preferably 25 μm or more, and has an upper limit value of preferably 100 μm or less, and more preferably 50 μm or less. If the thickness of the non-adherent, laterally wound insulation member 20 is within the above range, the insulation covered conductive wire 1 has superior insulation property under a vacuum and at high temperature, and can achieve higher output with space savings and electric power savings.

The non-adherent, laterally wound insulation member 20 is formed by laterally winding the multiple first ceramic fibers 21 on the outer circumference 10a of the conductive wire 10 without using an adhesive. For this reason, it is possible to simply produce the non-adherent, laterally wound insulation member 20. With a smaller number of layers of the non-adherent, laterally wound insulation member 20, it is possible to simply produce the non-adherent, laterally wound insulation member 20, and if the number of layers of the non-adherent, laterally wound insulation member 20 is one layer, it is possible to most simply produce the non-adherent, laterally wound insulation member 20.

The non-adherent braided insulation member 30 constituting the insulation covered conductive wire 1 covers the outer circumference 20a of the non-adherent, laterally wound insulation member 20. The non-adherent braided insulation member 30 does not adhere to the outer circumference 20a of the non-adherent, laterally wound insulation member 20. The non-adherent braided insulation member 30 is tubular, and conceals the outer circumference 20a of the non-adherent, laterally wound insulation member 20 along the longitudinal direction of the insulation covered conductive wire 1. A space S2 exists between the outer circumference 20a of the non-adherent, laterally wound insulation member 20 and the inner circumference 30b of the non-adherent braided insulation member 30.

The non-adherent braided insulation member 30 is made by braiding multiple second ceramic fibers 31 to the extending direction of the conductive wire 10 without being in close contact and adhering together. The plurality of second ceramic fibers 31 are respectively configured from a plurality of second ceramic strands 32. In the non-adherent braided insulation member 30, a gap G2 exists between the plurality of second ceramic fibers 31.

The non-adherent braided insulation member 30 is formed by braiding the multiple second ceramic fibers 31. Compared to an insulation member having a knitted structure such as a lateral winding, winding collapse of the non-adherent braided insulation member 30 having a braided structure can be suppressed. For this reason, adhesion between the non-adherent, laterally wound insulation member 20 and the non-adherent braided insulation member 30, and adhesion between multiple second ceramic fibers 31 are unnecessary.

As described above, the space S2 exists between the outer circumference 20a of the non-adherent, laterally wound insulation member 20 and the inner circumference 30b of the non-adherent braided insulation member 30, and the non-adherent braided insulation member 30 does not adhere to the outer circumference 20a of the non-adherent, laterally wound insulation member 20. Compared to a braided insulation member adhering with the outer circumference 20a of the non-adherent, laterally wound insulation member 20 via an adhesive, the non-adherent braided insulation member 30 of the insulation covered conductive wire 1 can suppress cracking of the non-adherent braided insulation member 30 due to the temperature change accompany a great temperature difference such as in outer space, caused by the difference between the thermal expansion of the non-adherent, laterally wound insulation member 20, thermal expansion of the non-adherent braided insulation member 30 and thermal expansion of the adhesive. For this reason, the insulation covered conductive wire 1 has a superior insulation property under a vacuum and at high temperature.

Furthermore, the non-adherent braided insulation member 30 is a braided structure formed by braiding of the multiple second ceramic fibers 31. The non-adherent braided insulation member 30 which is a braided structure has favorable elasticity in the radial direction. For this reason, it is possible to suppress cracking of the non-adherent braided insulation member 30 due to the temperature change accompanying a great temperature difference caused by the thermal expansion and thermal contraction of the non-adherent braided insulation member 30.

On the other hand, when using the insulation covered conductive wire 1 in an atmosphere such as on earth, since the space S2 exists between the non-adherent, laterally wound insulation member 20 and the non-adherent braided insulation member 30, the insulation property of the insulation covered conductive wire 1 is low compared to a conventional common insulation covered conductive wire. For this reason, in the case of using the insulation covered conductive wire 1 in the atmosphere, a restriction arises in the dielectric strength of the insulation covered conductive wire 1. For the insulation covered conductive wire 1 in a vacuum such as in outer space, the space S2 between the non-adherent, laterally wound insulation member 20 and the non-adherent braided insulation member 30 develops an insulation property, and thus functions as a gaseous insulation part.

In addition, the gap G2 exists between the multiple second ceramic fibers 31, and the multiple second ceramic fibers 31 are not in close contact and do not adhere with each other. Compared to a braided insulation member in which the multiple second ceramic fibers 31 adhere via an adhesive, the non-adherent braided insulation member 30 of the insulation covered conductive wire 1 can suppress cracking of the non-adherent braided insulation member 30 due to the temperature change accompanying a great temperature difference caused by the difference between the thermal expansion of the second ceramic fibers 31 and the thermal expansion of the adhesive. For this reason, the insulation covered conductive wire 1 has a superior insulation property under a vacuum and at high temperature.

On the other hand, when using the insulation covered conductive wire 1 in the atmosphere, since the gap G2 exists between the multiple second ceramic fibers 31, the insulation property of the insulation covered conductive wire 1 is low compared to a conventional common insulation covered conductive wire. For this reason, in the case of using the insulation covered conductive wire 1 in the atmosphere, a restriction arises in the dielectric strength of the insulation covered conductive wire 1. For the insulation covered conductive wire 1 in a vacuum such as in outer space, the gap G2 between the multiple second ceramic fibers 31 develops an insulation property, and thus functions as a gaseous insulating part.

For the insulation covered conductive wire 1, from the viewpoint of having superior insulation property under a vacuum and at high temperature, and achieving higher output with space savings and electric power savings, the material constituting the non-adherent braided insulation member 30, i.e. the second ceramic strands 32, is preferably a ceramic material with high electrical resistivity, and high melting temperature or high sublimation temperature. The ceramic material is more preferably a combination of silicon dioxide, aluminum trioxide, diboron trioxide, calcium oxide and magnesium oxide, and may include a trace amount of metal oxide. The multiple second ceramic strands 32 constituting the non-adherent braided insulation member 30 may be the same type of ceramic material, or may be different types of ceramic materials.

The electrical resistivity of the non-adherent braided insulation member 30 is preferably 1×10⁶ Ωcm or more at 25° C. If the electrical resistivity of the non-adherent braided insulation member 30 is within the above-mentioned range, the insulation covered conductive wire 1 has superior insulation property under a vacuum and at high temperature, and can achieve higher output with space savings and electric power savings.

The non-adherent braided insulation member 30 is not pyrolytically decomposed even for a long period of time, e.g., kept for 1 hour, preferably at 400° C. or higher, and more preferably at 600° C. or higher. Due to the non-adherent braided insulation member 30 not being pyrolytically decomposed in the above temperature ranges, even if the insulation covered conductive wire 1 is raised in temperature, it is possible to maintain the insulation state by the non-adherent braided insulation member 30. For this reason, the insulation covered conductive wire 1 has superior insulation property under a vacuum and at high temperature, and can achieve higher output with space savings and electric power savings.

The thickness of the tubular non-adherent braided insulation member 30 has a lower limit value of preferably 25 μm or more, and more preferably 50 μm or more, and has an upper limit value of preferably 200 μm or less, and more preferably 100 μm or less. If the thickness of the non-adherent braided insulation member 30 is within the above-mentioned range, the insulation covered conductive wire 1 has superior insulation property under a vacuum and at high temperature, and can achieve higher output with space savings and electric power savings.

The non-adherent braided insulation member 30 is formed by braiding the multiple second ceramic fibers 31 on the outer circumference 20a of the non-adherent, laterally wound insulation member 20, without using an adhesive. For this reason, it is possible to simply produce the non-adherent braided insulation member 30.

The synthetic electrical resistivity of the non-adherent, laterally wound insulation member 20 and the non-adherent braided insulation member 30 is preferably 1×10³ Ωcm or more at 25° C. If the above-mentioned synthetic electrical resistivity is within the above range, the insulation covered conductive wire 1 has superior insulation property under a vacuum and at high temperature, and can achieve higher output with space savings and electric power savings.

In the insulation covered conductive wire 1, the non-adherent, laterally wound insulation member 20 is formed by lateral winding the multiple first ceramic fibers 21 without using an adhesive, and the non-adherent braided insulation member 30 is formed by braiding the multiple second ceramic fibers 31 without using an adhesive. The insulation covered conductive wire 1 can be produced in this way.

In a case assuming the non-adherent, laterally wound insulation member 20 covering the outer circumference 10a of the conductive wire 10 as being a braided insulation member, it is necessary to braid each of this braided insulation member and the non-adherent braided insulation member 30. For this reason, compared to the insulation covered conductive wire 1 of the embodiment, the production process becomes complicated. On the other hand, in the insulation covered conductive wire 1 of the embodiment, the non-adherent, laterally wound insulation member 20 is formed by lateral winding, which is a simple process, and then the non-adherent braided insulation member 30 is formed by braiding not requiring adhesive. For this reason, it is possible to simply produce the insulation covered conductive wire 1.

Since the insulation covered conductive wire 1 can be used in a magnetic field generating coil as mentioned above, a shielding part made from a metal material is not provided to the outer circumference 30a of the non-adherent braided insulation member 30. For this reason, it is possible to achieve a size reduction in the insulation covered conductive wire 1.

The insulation covered conductive wire 1 is not equipped with an organic material such as a resin or rubber. In other words, an organic material is not formed on the outer circumference 20a and inner circumference 20b of the non-adherent, laterally wound insulation member 20, and on the outer circumference 30a and inner circumference 30b of the non-adherent braided insulation member 30. In addition, the non-adherent, laterally wound insulation member 20 and the non-adherent braided member 30 are not impregnated with an organic material. Even if the insulation covered conductive wire 1 is raised in temperature, the respective members constituting the insulation covered conductive wire 1 will not decompose, and defects such as cracks and peeling will not arise. For this reason, the insulation covered conductive wire 1 has superior insulation property under a vacuum and at high temperature, and can achieve higher output with space savings and electric power savings.

The AC breakdown voltage in a vacuum of 100 Pa or less of the insulation covered conductive wire 1 is preferably 400 V or more. If the above-mentioned breakdown strength of the insulation covered conductive wire 1 is within the above-mentioned range, due to having superior insulation property under a vacuum and at high temperature, it is also possible to apply to a high-output magnetic field generating coil. The above-mentioned AC breakdown voltage of the insulation covered conductive wire 1 is measured based on JIS C 3216-5 (2011).

The insulation covered conductive wire 1 is preferably used in a magnetic field generating coil for which superior insulation property under a vacuum and at high temperature, simply production, and a size reduction and increased output are demanded. As such a magnetic field generating coil, a magnetic field generating coil equipped to the thruster of a spacecraft is preferable, and thereamong, it can be favorably used in a magnetic field generating coil equipped to a thruster necessitating a large magnetic field such as a Hall-effect thruster or MPD thruster, for which higher output with space savings and electric power savings are demanded.

Next, usage examples of the insulation covered conductive wire 1 of the embodiment will be explained.

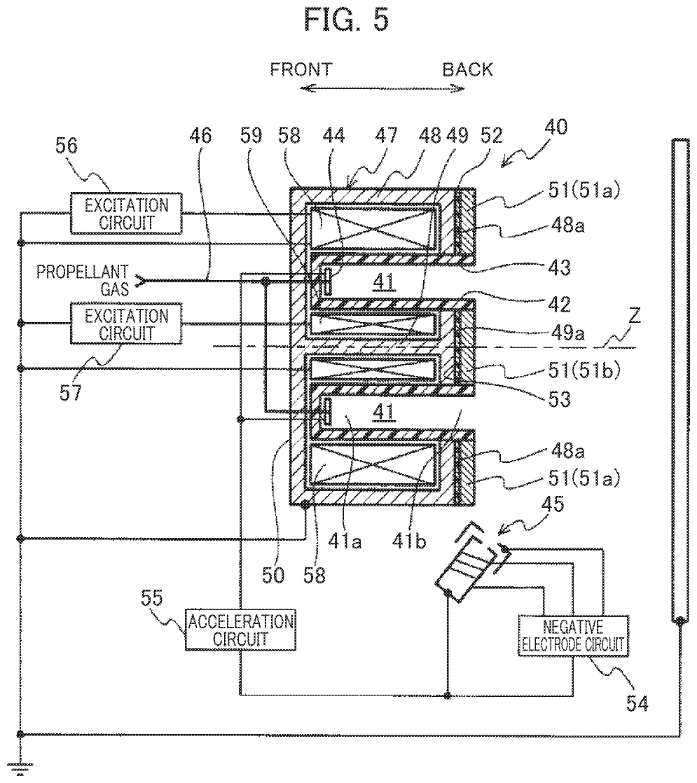

FIG. 5 is a schematic drawing showing an example of a usage example of the insulation covered conductive wire 1 according to an embodiment. As shown in FIG. 5, the insulation covered conductive wire 1 can be used in the insulation covered conductive wire of the external coil 58 and the insulation covered conductive wire of the internal coil 59 equipped to the Hall-effect thruster 40, which is the thruster of a spacecraft.

The Hall-effect thruster 40 is the thruster of a spacecraft which achieves propulsion by generating plasma of propellent gas, and emitting ions in the plasma by an electric field. The Hall-effect thruster 40 includes a ring-shaped channel 41, a positive electrode 44, a negative electrode 45, a supply channel 46 of propellant gas, a magnetic circuit 47, and a cover 51.

The ring-shaped channel 41 is a flow path of propellant gas and plasma thereof, defined by concentric inner circumferential wall 42 and outer circumferential wall 43 centered around the Z axis. The inner circumferential wall 42 and the outer circumferential wall 43 include a cylindrical structure centered around the Z axis, and extend along the Z axis.

The length of the ring-shaped channel 41 along the Z axis is shorter than the ion cyclotron radius, and longer than the electron cyclotron radius. In addition, the length of the ring-shaped channel 41 along the Z axis is sufficiently longer than the width of the ring-shaped channel 41 in the radial direction. In addition, the inner circumferential wall 42 and the outer circumferential wall 43 defining the ring-shaped channel 41 are formed from ceramic such as boron nitride.

The inner circumferential wall 42 and the outer circumferential wall 43 connect ahead of the Hall-effect thruster 40 (upstream side of the ring-shaped channel 41), and form a closed end 41a blocking the ring-shaped channel 41. In addition, the inner circumferential wall 42 and the outer circumferential wall 43 form an open end 41b of the ring-shaped channel 41 behind the Hall-effect thruster 40 (downstream side of the ring-shaped channel 41). The open end 41b functions as an outlet of propellent gas and plasma thereof.

The positive electrode 44 is arranged at the closed end 41a of the ring-shaped channel 41. The positive electrode 44 generates an acceleration electric field of ions with the negative electrode 45, via the ring-shaped channel 41. The supply path 46 of the propellant gas opens at the surface of the positive electrode 44 which meets with the closed end 41a of the ring-shaped channel 41.

The negative electrode 45 supplies electrons to the ring-shaped channel 41, and neutralizes the plasma discharged from the open end 41b of the ring-shaped channel 41. A negative electrode circuit 54 is connected to the negative electrode 45.

An acceleration circuit 55 is connected in series between the positive electrode 44 and the negative electrode 45. The acceleration circuit 55 forms an acceleration electric field of ions flowing from front towards the back of the Hall-effect thruster, between the positive electrode 44 and the negative electrode 45 via the ring-shaped channel 41.

The supply path 46 of the propellant gas communicates with the closed end 41a of the ring-shaped channel 41, and supplies the propellant gas inside the ring-shaped channel 41. A noble gas having low corrosiveness and easily ionizing such as xenon or krypton can be used as the propellant gas.

The magnetic circuit 47 includes an outer magnetic pole 48, an inner magnetic pole 49 and a yoke 50. The outer magnetic pole 48, the inner magnetic pole 49 and the yoke 50 are formed with materials having ferromagnetism such as iron.

The outer magnetic pole 48 is arranged more outwards in the radial direction than the outer circumferential wall 43. An outer coil 58 for generating a magnetic field is installed at the outer magnetic pole 48. The outer coil 58, which is a magnetic field generating coil, includes the insulation covered conductive wire 1. An excitation circuit 56 including a power source, etc. is connected to the outer coil 58, and the magnetic field is controlled by the outer coil 58.

The inner magnetic pole 49 is arranged more inwards in the radial direction than the inner circumferential wall 42. An inner coil 59 for generating a magnetic field is installed at the inner magnetic pole 49. The inner coil 59, which is a magnetic field generating coil, includes the insulation covered conductive wire 1. An excitation circuit 57 including a power source, etc. is connected to the inner coil 59, and the magnetic field is controlled by the inner coil 59.

The yoke 50 is provided to the side of the closed end 41a of the ring-shaped channel 41, contacts the outer magnetic pole 48 and the inner magnetic pole 49, and magnetically joins the outer magnetic pole 48 and the inner magnetic pole 49.

The outer magnetic pole 48 and the inner magnetic pole 49 magnetically join via the yoke 50 on the forward side of the Hall-effect thruster 40. On the other hand, the outer magnetic pole 48 and the inner magnetic pole 49 separate from each other via the ring-shaped channel 41 near the open end 41b of the ring-shaped channel 41. For this reason, when the magnetic field generates by way of the outer coil 58 and the inner coil 59, while the magnetic field joins via the yoke 50, the magnetic field leaks to the ring-shaped channel 41 on the rearward side of the Hall-effect thruster 40. The leaked magnetic field disperses axisymmetrically and radially around the Z axis, and produces cyclotron motion in the electrons emitted from the negative electrode 45.

The Hall-effect thruster 40 includes the cover 51 of the magnetic circuit 47 at the rear thereof. The cover 51 exposes towards the rear of the Hall-effect thruster 40 at a position which is exposed to plasma of the propellant gas. Such a cover 51 protects the outer magnetic pole 48 and the inner magnetic pole 49 from plasma dispersing near the open end 41b of the ring-shaped channel 41. The cover 51 has heat resistance and electrical conductivity.

The cover 51 includes a ring-shaped part 51a and a circular part 51b. The ring-shaped part 51a of the cover 51 covers the end face 48a of the outer magnetic pole 48 positioned at the open end 41b side of the ring-shaped channel 41. The insulation member 52 is provided between the ring-shaped part 51a of the cover 51 and the end face 48a of the outer magnetic pole 48. The circular part 51b of the cover 51 covers the end face 49a of the inner magnetic pole 49 positioned at the open end 41b side of the ring-shaped channel 41, via the insulation member 53. The cover 51 is electrically floating.

A positive side of the acceleration circuit 55 connects to the positive electrode 44, and a negative side of the acceleration circuit 55 connects to an electron emitting member of the negative electrode 45. The acceleration circuit 55 forms a predetermined acceleration electric field between the positive electrode 44 and the negative electrode 45. The acceleration circuit 55 is not electrically connected with the excitation circuit 56 or the excitation circuit 57.

Since the cover 51 is electrically floating, while the plasma is being generated, the potential of the cover 51 becomes negative relative to common of the Hall-effect thruster 40 or the magnetic circuit 47. On the other hand, the electrons emitted from the negative electrode 45 traverse the cover 51 on the way to the positive electrode 44 in the ring-shaped channel 41 by way of the acceleration electric field. Since the potential of the cover 51 is negative relative to the common of the Hall-effect thruster 40 or the magnetic circuit 47, the electrons become unlikely to collide with the cover 51, and the probability of reaching the positive electrode 44 or the ions in the plasma rises.

The insulation covered conductive wire 1 of the Hall-effect thruster 40 including such a configuration can be used in the outer coil 58 and the inner coil 59, which are magnetic field generating coils, as described above. The insulation covered conductive wire 1 of the Hall-effect thruster 40 has a superior insulation property under a vacuum and at high temperature, and can achieve higher output with space savings and electric power savings.

According the embodiment explained above, it is possible to obtain the insulation covered conductive wire which can be used in a magnetic field generating coil, has superior insulation property under a vacuum and at high temperature, can be simply produced, and can achieve a size reduction and increased output, by focusing on the knitting structure of two types of insulation members covering the outer circumference of the conductive wire, the coverage state of these insulation members without adhesion, as well as the non-use of organic materials.

Although an embodiment has been explained above, the present invention is not to be limited to the above embodiment, and includes all aspects encompassed by the gist of the present disclosure and scope of claims, and various modifications are possible within the scope of the present disclosure.

### EXPLANATION OF REFERENCE NUMERALS

1 insulation covered conductive wire
10 conductive wire
10a outer circumference of conductive wire
20 non-adherent, laterally wound insulation member
20a outer circumference of non-adherent, laterally wound insulation member
20b inner circumference of non-adherent, laterally wound insulation member
21 first ceramic fiber
22 first ceramic strand
30 non-adherent braided insulation member
30a outer circumference of non-adherent braided insulation member
30b inner circumference of non-adherent braided insulation member
31 second ceramic fiber
32 second ceramic strand
40 Hall-effect thruster
41 ring-shaped channel
41a closed end
41b open end
42 inner circumference wall
43 outer circumference wall
44 positive electrode
45 negative electrode
46 supply path
47 magnetic circuit
48 outer magnetic pole
48a end face
49 inner magnetic pole
49a end face
50 yoke
51 cover
51a ring-shaped part
51b circular part
52, 53 insulation member
54 negative electrode circuit
55 acceleration circuit
56 excitation circuit
57 excitation circuit
58 outer coil
59 inner coil

S1, S2 space

G1, G2 gap

1. An insulation covered conductive wire, comprising:
a conductive wire;
a non-adherent, laterally wound insulation member which covers an outer circumference of the conductive wire without adhering thereto, and is formed by laterally winding a plurality of first ceramic fibers constituted from a plurality of first ceramic strands in an extending direction of the conductive wire, wherein the first ceramic strands are not in contact with each other and do not adhere to each other; and
a non-adherent braided insulation member which covers an outer circumference of the non-adherent, laterally wound insulation member without adhering thereto, and is formed by braiding a plurality of second ceramic fibers constituted from a plurality of second ceramic strands, wherein the second ceramic fibers are not in contact with each other and do not adhere to each other.

2. The insulation covered conductive wire according to claim 1, wherein the conductive wire has an electrical resistivity of 1×10⁻⁵ Ωcm or less at 25° C. under a pressure of 100 Pa, and 1×10⁻⁵ Ωcm or less at a temperature 100° C. lower than a melting temperature or pyrolysis temperature of the conductive wire under a pressure of 100 Pa.

3. The insulation covered conductive wire according to claim 1 wherein the non-adherent, laterally wound insulation member and the non-adherent braided insulation member have synthetic electrical resistivities of 1×10³ Ωcm or more at 25° C.

4. The insulation covered conductive wire according to claim 1, wherein the insulation covered conductive wire has an AC breakdown voltage of 400 V or more in a vacuum of 100 Pa or less.

5. The insulation covered conductive wire according to claim 1, wherein the non-adherent, laterally wound insulation member and the non-adherent braided insulation member are not pyrolytically decomposed at a temperature of 400° C. or higher.

6. The insulation covered conductive wire according to claim 2, wherein the non-adherent, laterally wound insulation member and the non-adherent braided insulation member have synthetic electrical resistivities of 1×10³ Ωcm or more at 25° C.

7. The insulation covered conductive wire according to claim 2, wherein the insulation covered conductive wire has an AC breakdown voltage of 400 V or more in a vacuum of 100 Pa or less.

8. The insulation covered conductive wire according to claim 3, wherein the insulation covered conductive wire has an AC breakdown voltage of 400 V or more in a vacuum of 100 Pa or less.

9. The insulation covered conductive wire according to claim 2, wherein the non-adherent, laterally wound insulation member and the non-adherent braided insulation member are not pyrolytically decomposed at a temperature of 400° C. or higher.

10. The insulation covered conductive wire according to claim 3, wherein the non-adherent, laterally wound insulation member and the non-adherent braided insulation member are not pyrolytically decomposed at a temperature of 400° C. or higher.

11. The insulation covered conductive wire according to claim 4, wherein the non-adherent, laterally wound insulation member and the non-adherent braided insulation member are not pyrolytically decomposed at a temperature of 400° C. or higher.
